(19) United States
(12) Patent Application Publication
(10) Pub. No.: US 2019/0133722 A1
(43) Pub. Date: May 9, 2019

(54) ARTIFICIAL DENTURE

(71) Applicants: Wen-Yuen WU, Kaohsiung City (TW); Yi-Hsun LEE, New Taipei City (TW)

(72) Inventor: Wen-Yuen WU, Kaohsiung City (TW)

(21) Appl. No.: 16/183,197

(22) Filed: Nov. 7, 2018

(30) Foreign Application Priority Data
Nov. 8, 2017 (TW) 106138671

(51) Int. Cl. A61C 8/00; A61C 13/225

(52) U.S. Cl. CPC A61C 8/0086; A61C 8/0063; A61C 13/225; A61C 8/0069

(57) ABSTRACT

The disclosure provides an artificial denture which is configured to fixed to a carrier. The artificial denture includes a first inner component, a second inner component and a tooth crown. The first inner component is configured to be fixed to the carrier. The first inner component includes a first cover and a first post connected to each other. The first post has a hole. The second inner component includes a second cover and a second post connected to each other. The second cover is detachably sleeved on the first cover, and the second post is inserted in the hole of the first post so as to be fixed to the first inner component. The tooth crown covers the second cover of the second inner component.

### CROSS-REFERENCE TO RELATED APPLICATIONS

This non-provisional application claims priority under 35 U.S.C. § 119(a) on Patent Application No(s). 106138671 filed in Taiwan, R.O.C on Nov. 8, 2018, the entire contents of which are hereby incorporated by reference.

### TECHNICAL FIELD

The disclosure relates to an artificial denture, more particularly an artificial denture having a first inner component and a second inner component.

### BACKGROUND

Dental bridges literally bridge the gap created by one or more missing teeth. A bridge is made up of two or more crowns for the teeth on either side of the gap, these two or more anchoring teeth are called abutment teeth, and a false tooth/teeth in between. However, in order to do the dental bridge, the patient has to modify his/her healthy teeth to support it. The abutment teeth will have to be sculpted down to accommodate the crowns at the ends of the bridge. Modifying the teeth will leave them weaker than before, and an increased risk of tooth damage or infection (tooth decay).

Therefore, the dental implant becomes an alternative to missing teeth, it is usually placed into a carrier which is embedded into alveolar bone. However, the force caused by activities such as chewing and biting will apply on the alveolar bone through the carrier, which makes the alveolar bone to break easily.

### SUMMARY OF THE INVENTION

The disclosure provides an artificial denture which is capable of decreasing the risk of breaking the alveolar bone.

One embodiment of the disclosure provides an artificial denture which is configured to fixed to a carrier. The artificial denture includes a first inner component, a second inner component and a tooth crown. The first inner component is configured to be fixed to the carrier. The first inner component includes a first cover and a first post connected to each other. The first post has a hole. The second inner component includes a second cover and a second post connected to each other. The second cover is detachably sleeved on the first cover, and the second post is inserted in the hole of the first post so as to be fixed to the first inner component. The tooth crown covers the second cover of the second inner component.

According to the artificial denture as discussed above, the artificial denture has the second inner component movably inserted into the first inner component which is embedded into the carrier, therefore the outer force applied on the tooth crown is equivalently applying on the contact point of the first and second inner components which is closer to the alveolar bone than the tooth crown. As such, the torque on the alveolar bone is reduced, thereby decreasing the risk of breaking the alveolar bone.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an artificial denture according to a first embodiment of the disclosure;

FIG. 2 is a partially exploded view of the artificial denture in FIG. 1;

FIG. 3 is a detail exploded view of the artificial denture in FIG. 1;

FIG. 4 is a partial cross-sectional view of the artificial denture in FIG. 1;

FIG. 5 is a perspective view of the first component in FIG. 2 when the first post is in the removable state;

FIG. 6 is a perspective view of the first component in FIG. 2 when the first post is in the engaged state;

FIG. 7 is an exploded view of a first inner component and a second component of an artificial denture according to a second embodiment of the disclosure;

FIG. 8 is an exploded view of a first inner component and a second component of an artificial denture according to a third embodiment of the disclosure;

FIG. 9 is an exploded view of a first inner component and a second component of an artificial denture according to a fourth embodiment of the disclosure;

FIG. 10 is an exploded view of a first inner component and a second component of an artificial denture according to a fifth embodiment of the disclosure;

FIG. 11 is an exploded view of a first inner component and a second component of an artificial denture according to a sixth embodiment of the disclosure; and

FIG. 12 is a cross-sectional view of the first inner component and the second component in FIG. 11.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

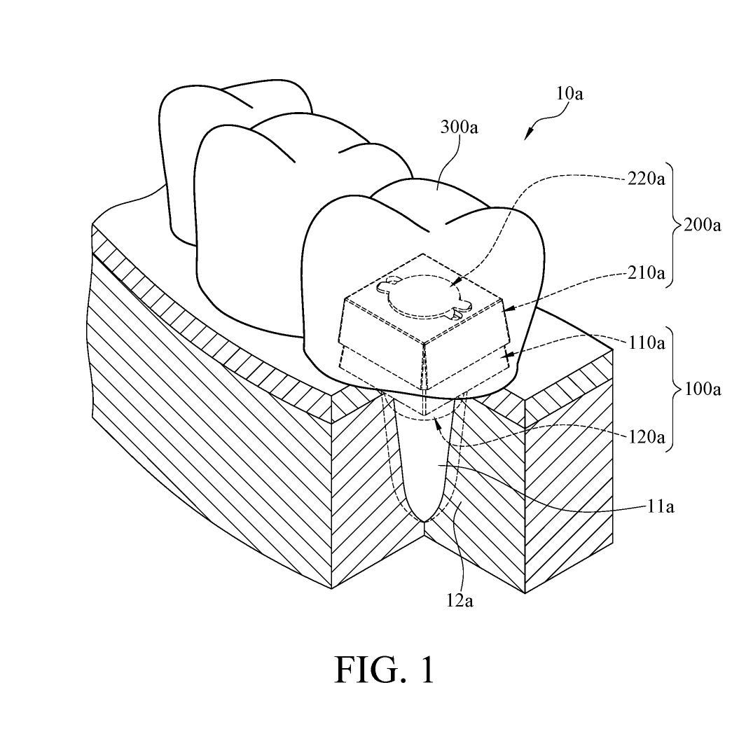

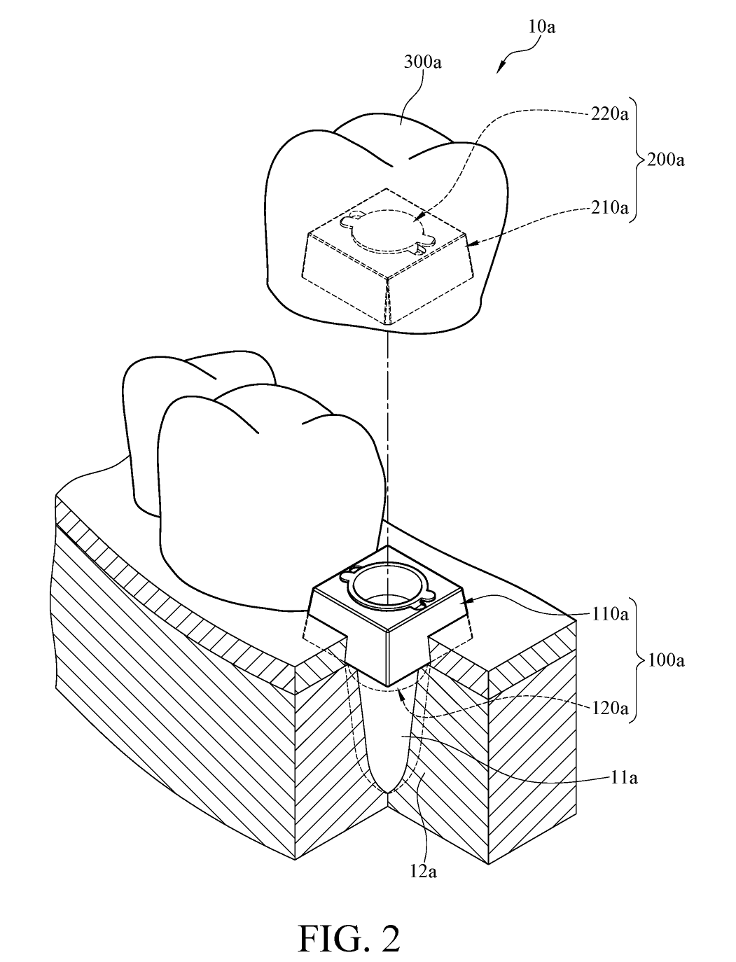

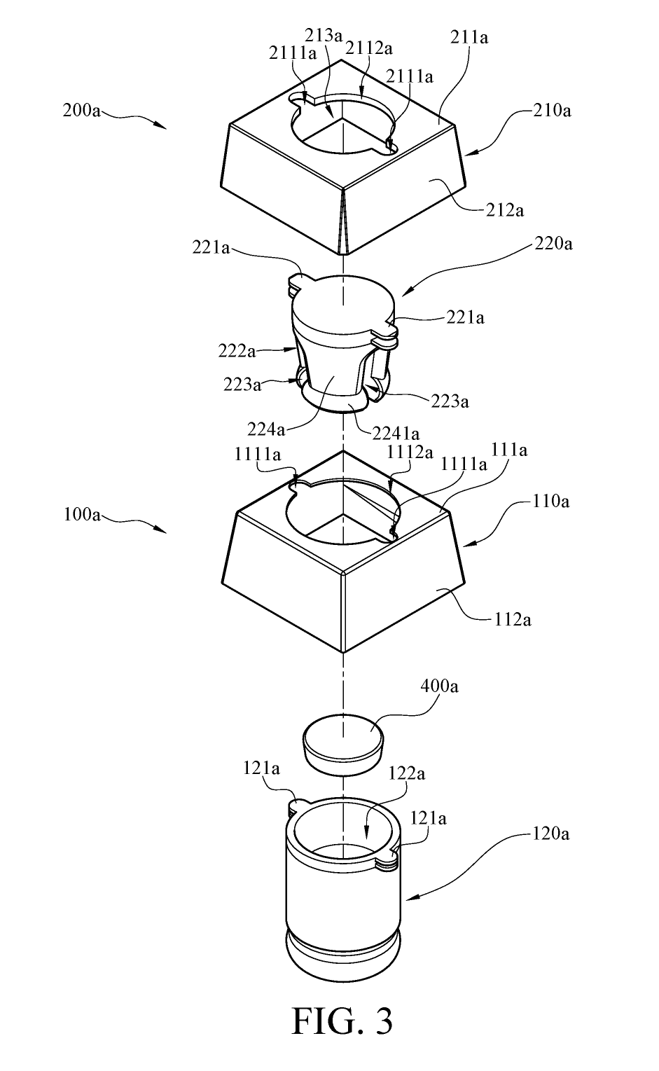

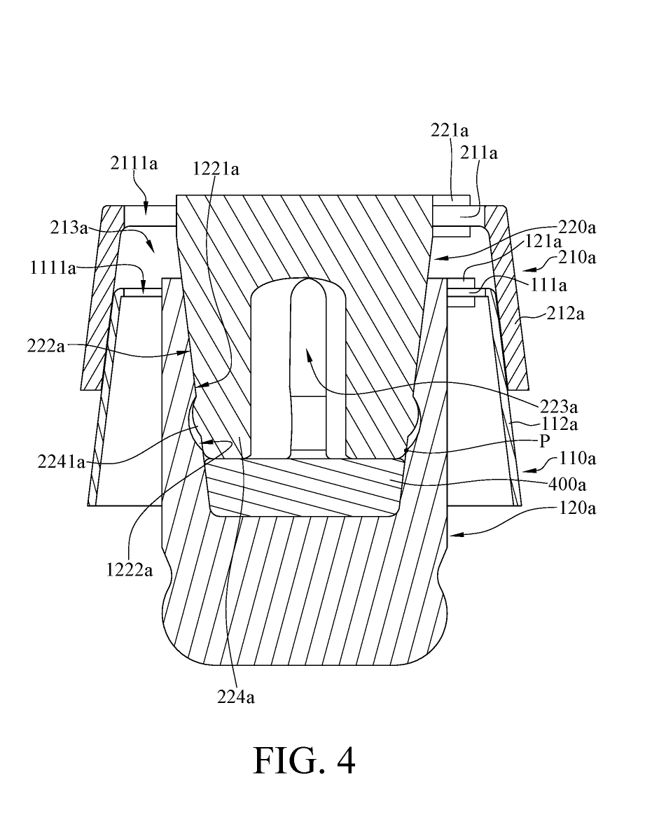

Please refer to FIG. 1 and FIG. 4. FIG. 1 is a perspective view of an artificial denture according to a first embodiment of the disclosure. FIG. 2 is a partially exploded view of the artificial denture in FIG. 1. FIG. 3 is a detail exploded view of the artificial denture in FIG. 1. FIG. 4 is a partial cross-sectional view of the artificial denture in FIG. 1.

This embodiment provides an artificial denture 10a (also known false tooth) which is adapted to be fixed to a carrier 11a that can be planted on the alveolar bone 12a. The carrier 11a is, for example, a removable implant for dental implant or a tooth had been through a root canal treatment. In this embodiment, the artificial denture 10a includes a first inner component 100a, a second inner component 200a and a tooth crown 300a. The first inner component 100a can be screwed into the carrier 11a.

The first inner component 100a includes a first cover 110a and a first post 120a connected to each other. The first cover 110a includes a first top plate 111a and a first side wall 112a. The first top plate 111a has a first through hole 1112a and two recess openings 1111a connected to the first through hole 1112a. Specifically, the recess openings 1111a are respectively connected to two opposite sides of the first through holes 1112a.

The first post 120a has two protrusions 121a, a hole 122a, an annular inner surface 1221a and a first positioning portion 1222a. The two protrusions 121a respectively protrude from two opposite sides of the first post 120a in a radial direction of the first post 120a. In more detail, each protrusion 121a has a slot (not numbered) for receiving a portion of the first top plate 111a. The hole 122a is formed by the annular inner surface 1221a and is a cone-shaped hole. The first positioning portions 1222a is formed on the annular inner surface 1221a and is, for example, an annular groove.

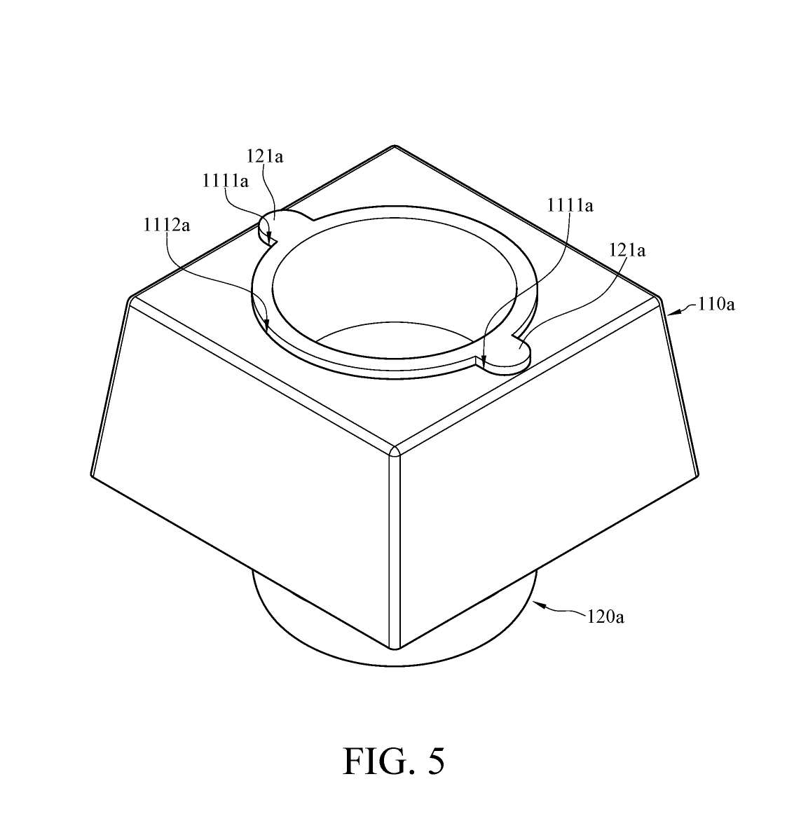

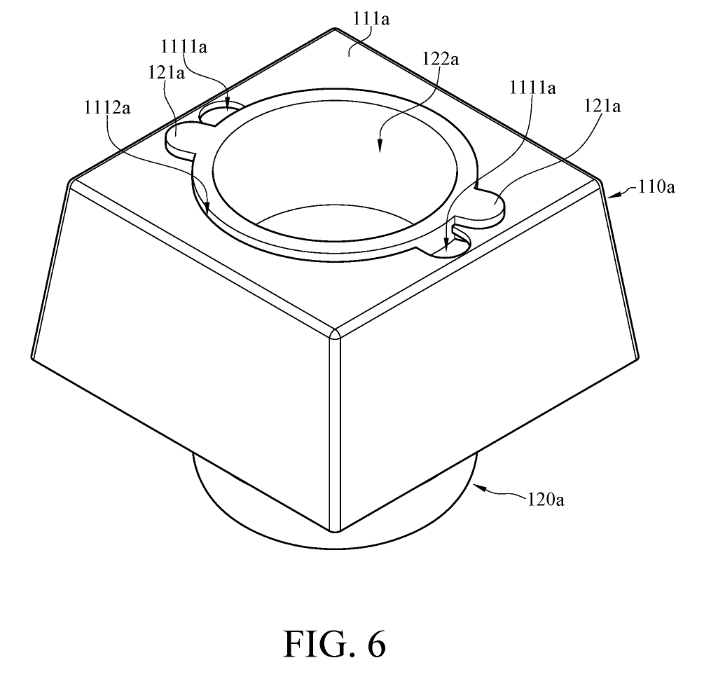

Then, please refer to FIGS. 3, 5 and 6. FIG. 5 is a perspective view of the first component in FIG. 2 when the first post is in the removable state. FIG. 6 is a perspective view of the first component in FIG. 2 when the first post is in the engaged state.

As shown in FIG. 5, the protrusions 121a are respectively aligned with the recess openings 1111a so that the protrusions 121a are able to pass through the recess openings 1111a. At this moment, the first post 120a is in a removable state and is allowed to pass through the first through hole 1112a in either direction.

Then, as shown in FIG. 6, the first post 120a or the first cover 110a is rotated to misalign the protrusions 121a and the recess openings 1111a, a portion of the edge that forms the first through hole 1112a of the first top plate 111a is engaged into the slots of the protrusions 121a so that the first post 120a is engaged with the first cover 110a. At this moment, the first post 120a is in an engaged state. In addition, when the first post 120a is disposed at the first through hole 1112a of the first top plate 111a, the hole 122a of the first post 120a is not covered by the first top plate 111a.

As such, the cooperation of the protrusions 121a and the recess opening 1111a achieve the engagement and removal of the first post 120a and the first cover 110a.

Then, as shown in FIG. 3 and FIG. 4, the second inner component 200a includes a second cover 210a and a second post 220a. The second cover 210a includes a second top plate 211a and a second side wall 212a connected to each other. The second top plate 211a and the second side wall 212a form an accommodating space 213a therebetween. The accommodating space 213a is configured to accommodate the first cover 110a. The second top plate 211a has a second through hole 2112a and the two recess openings 2111a connected to the second through hole 2112a. Specifically, the recess openings 2111a are respectively connected to two opposite sides of the second through hole 2112a.

The second post 220a has an outer surface 222a, two protrusions 221a and three buffering hole 223a. The two protrusions 221a respectively protrude from two opposite sides of the outer surface 222a in a radial direction of the second post 220a. In more detail, each protrusion 221a has a slot (not numbered) for receiving a portion of the second top plate 211a.

The second post 220a is movably located at the second through hole 2112a. In this embodiment, the second post 220a is also rotatable between a removable state and an engaged state that are similar to the first post 110 of the first inner component 100a. Therefore, when the second post 220a is in the removable state, the protrusions 221a are respectively aligned with the recess openings 2111a so that the second post 220a is allowed to pass through the second cover 210a in either direction; when the second post 220a is in the engaged state, the protrusions 221a are respectively misaligned with the recess openings 2111a, a portion of the edge that forms the second through hole 2112a of the second top plate 211a is engaged into the slots of the protrusions 221a so that the second post 220a is engaged with the second cover 210a. As such, the cooperation of the protrusions 221a and the recess openings 2111a achieve the engagement and removal of the second post 220a and the second cover 210a.

The buffering holes 223a are formed on the outer surface 222a and divide the second post 220a into three buffering parts 224a. Each of the buffering parts 224a has a second positioning portion 2241a located at a side of the buffering part 224a away from the second cover 210a. Each second positioning portion is, for example, a flange. The purpose of the buffering part 224a will be illustrated in the later paragraphs.

The quantities of the recess openings 1111a and the protrusions 121a of the first inner component 100a are not restricted. In some other embodiments, the quantities of the recess openings and the protrusions may both larger than two. In addition, the positions of the recess openings and protrusions are not restricted; in some other embodiments, the recess openings may be located at other sides of the first through hole, and the protrusions may be located at other sides of first post. Furthermore, the quantities of the recess openings and protrusions of the second inner component are not restricted and may be larger than two, the recess openings of the second inner component may be located at other sides of the second through hole, and the protrusions may be located at other sides of the second post in some other embodiments in some other embodiments. Moreover, the quantity of the buffering holes 223a is not restricted and may be less or larger than three in some other embodiments; in such a case, the quantity of the buffering parts will be changed accordingly.

The artificial denture 10a further includes a buffering component 400a. The buffering component 400a is made of, for example, polytetrafluoroethene (i.e., PTFE), but the present disclosure is not limited thereto. In some other embodiments, the buffering component may be made of rubber. The buffering component 400a is disposed at the button of the hole 122a.

The second cover 210a is stacked on the first cover 110a and covers a portion of the first cover 110a; that is, a portion of the first cover 110a is accommodated in the accommodating space 213a of the second cover 210a. In such a case, the second side wall 212a of the second cover 210a is in contact with the first side wall 112a of the first cover 110a. The three buffering parts 224a of the second post 220a are inserted in the hole 122a of the first post 120a. The buffering parts 224a are in contact with the buffering component 400a, and the second positioning portions 2241a are located at the first positioning portion 1222a so that the second inner component 200a is fixed on the first inner component 100a. The tooth crown 300a covers the second cover 210a of the second inner component 200a. for creating an appearance similar to a real tooth.

In this embodiment, when the second inner component 200a is installed in the first inner component 100a, and the second positioning portions 2241a are located at the first positioning portion 1222a, there is still a portion of the first positioning portion 1222a not occupied by the second positioning portions 2241a and can allow the second inner component 200a to further move toward the first inner component 100a. Therefore, when a force is applied on the tooth crown 300a along an axial direction of the first post 120a, the second inner component 200a still has a small distance to move so as to press against the buffering component 400a with the three buffering parts 224a, such that the buffering component 400a can absorb the force.

It is noted that, in some other embodiments, the first positioning portion may be a flange, and the second positioning portion may be an annular groove.

In addition, the buffering component 400a is optional. In some other embodiments, there may be no buffering component. As such, the second post may be in direct contact with the button of the first post.

The buffering holes 223a allows the buffering parts 224a to be deformed. During the movement of the three buffering parts 224a, the three buffering parts 224a are in contact with the annular inner surface 1221a so as to force the three buffering pars 224a to deform to decrease the buffering holes 223a, which also helps to absorb the force applied on the artificial denture 10a in the radial direction of the first post 120a. When the force is removed, the buffering component 400a will rebound and move the three buffering parts 224a back to their original locations.

As such, the artificial denture 10a can resist the forces in both the axial and radial direction of the first post 120a, thereby preventing the alveolar bone 12a from being broken by the artificial denture 10a.

As shown in FIG. 4, the second post 220a inserted into the hole 122a of the first post 120a, and the first inner component 100a and the second inner component 200a have a contact point P located closer to the alveolar bone 12a than the tooth crown 300a (as shown in FIG. 1). As such, the force, caused by activities such as chewing and biting, applied on the tooth crown 300a is equivalently applying on the contact point P. Therefore, the torque on the alveolar bone 12a is reduced, thereby decreasing the risk of breaking the alveolar bone 12a.

The disclosure is not limited to how the first post 120a is mounted on the first cover 110a and how the second post 220a is mounted on the second cover 210a.

The followings are some other embodiments of the artificial denture that are similar to that in the previous embodiment, thus only the difference between them will be illustrated in the following paragraphs.

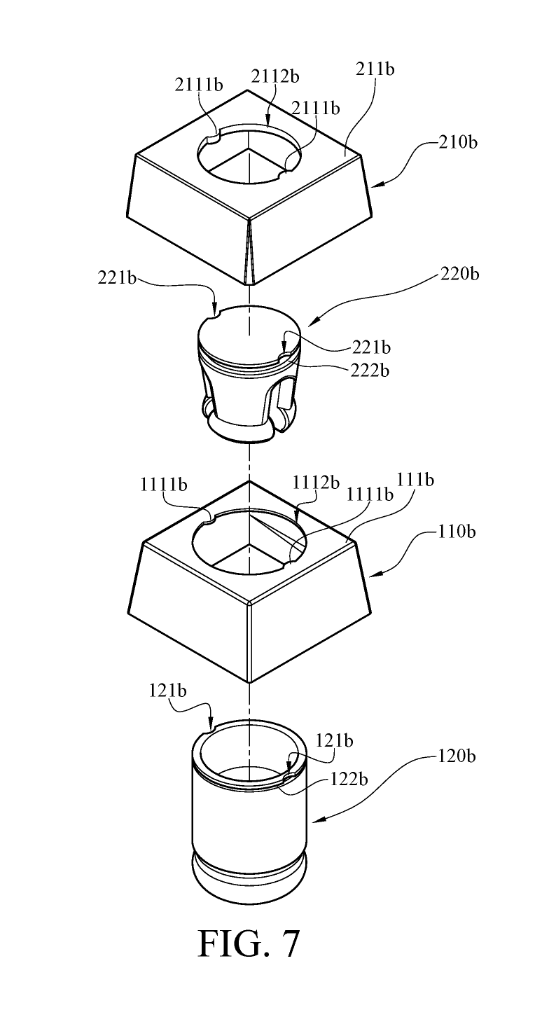

Please refer to FIG. 7. FIG. 7 is an exploded view of a first inner component and a second component of an artificial denture according to a second embodiment of the disclosure.

In the second embodiment, a first top plate 111b of a first cover 110b has two protrusions 1111b and a first through hole 1112b. The two protrusions 1111b are located at two opposite sides of the first through hole 1112b. A first post 120b has two recess openings 121b and an annular groove 122b. The two recess openings 121b are connected to two opposite sides of the annular groove 122b. The two protrusions 1111b are located in the annular groove 122b, and the first post 120b is rotatable between a removable state and an engaged state. When the first post 120b is in the removable state, the two protrusions 1111b are respectively aligned with the two recess openings 121b so that first post 120b is allowed to pass through the first cover 110b in either direction. When the first post 120b is in the engaged state, the two protrusions 1111b are respectively misaligned with the two recess openings 121b so that the first post 120b is engaged with the first cover 110b.

In addition, a second top plate 211b of a second cover 210b has two protrusions 2111b and a second through hole 2112b. The two protrusions 2111b are located at two opposite sides of the second through hole 2112b. A second post 220b has two recess openings 221b and an annular groove 222b. The two recess openings 221b are connected to two opposite sides of the annular groove 222b. The two protrusions 2111b are located in the annular groove 222b, and the second post 220b is rotatable between a removable state and an engaged state. The removable state and the engaged state of the second post 220b is similar to the removable state and the engaged state of the first post 120b. That is, when the second post 220b is in the removable state, the two protrusions 2111b are respectively aligned with the two recess openings 221b so that the second post 220b is allowed to pass through the second cover 210b in either direction. When the second post 220b is in the engaged state, the two protrusions 2111b are respectively misaligned with the two recess openings 221b so that the second post 220b is engaged with the second cover 210b.

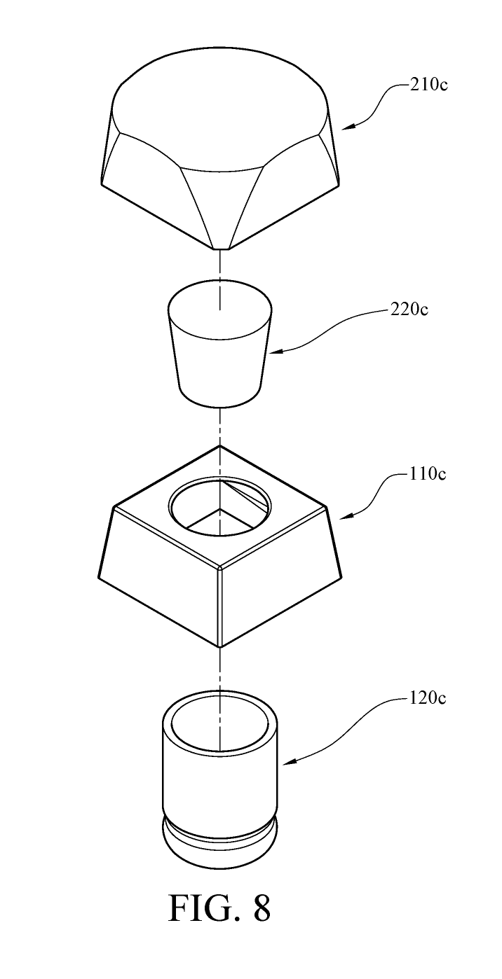

Then, please refer to FIG. 8. FIG. 8 is an exploded view of a first inner component and a second component of an artificial denture according to a third embodiment of the disclosure.

In this embodiment, a first post 120c and a first cover 110c respectively have no protrusion and recess opening, and a second post 220c and a second cover 210c respectively have no protrusion and recess opening. Instead, the first post 120c is directly mounted on the first cover 110c by a welding manner or a glue manner. Similarly, the second post 220c is directly mounted on the second cover 210c by the welding manner or the glue manner.

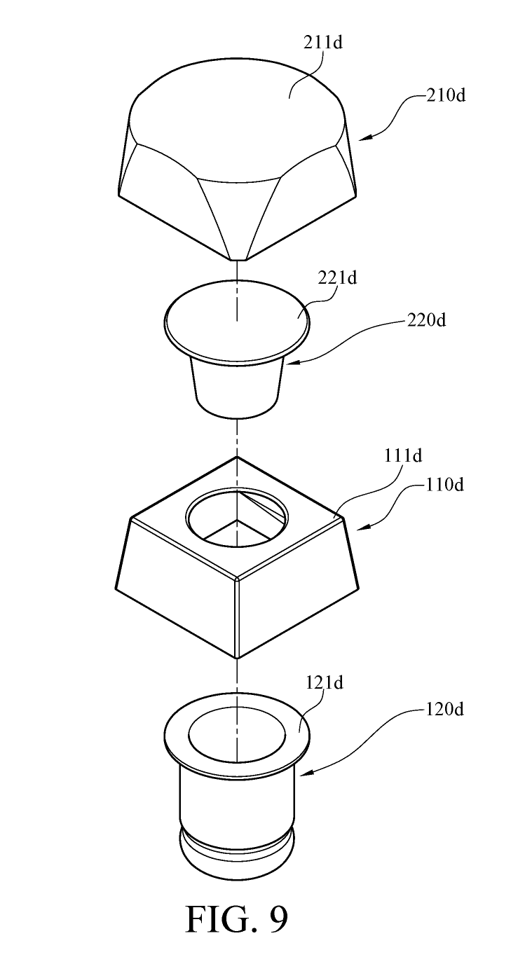

Then, please refer to FIG. 9. FIG. 9 is an exploded view of a first inner component and a second component of an artificial denture according to a fourth embodiment of the disclosure.

In this embodiment, compare with the first post 120c in the FIG. 8, a first post 120d further has an annular flange 121d. The annular flange 121d protrudes from the first post 120d in a radial direction thereof, and the annular flange 121d is located at a side of the first post 120d close to a first cover 110d. The annular flange 121d is mounted on a first top plate 111d of the first cover 110d by a welding manner or a glue manner so as to fix the first post 120d to the first cover 110d. A second post 220d further has an annular flange 221d. The annular flange 221d protrudes from the second post 220d in a radial direction thereof, and the annular flange 221d is located at a side of the second post 220d close to a second cover 210d. The annular flange 221d is mounted on a second top plate 211d of the second cover 210d by the welding manner or the glue manner so as to fix the second post 220d to the second cover 210d.

In addition, the annular flange 121d can increase the contact area between the first post 120d and the first cover 110d, thus the fixing strength between the first post 120d and the first cover 110d can be increased. Similarly, the annular flange 221d also increase the fixing strength between the second post 220d and the second cover 210d.

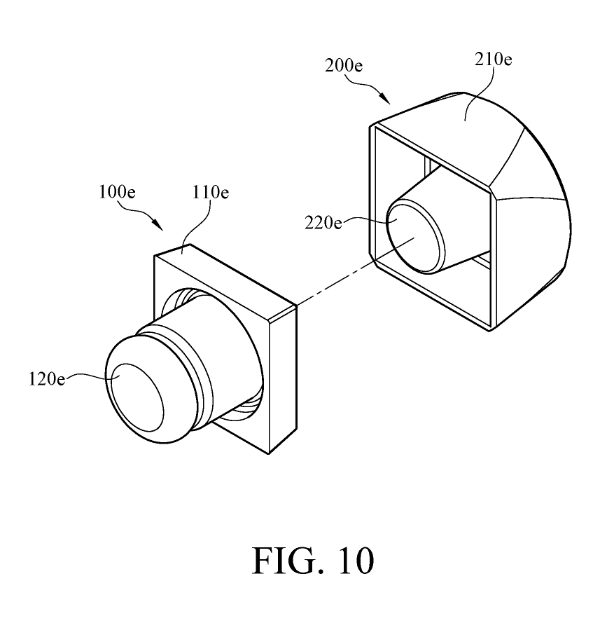

Then please refer to FIG. 10. FIG. 10 is an exploded view of a first inner component and a second component of an artificial denture according to a fifth embodiment of the disclosure.

In this embodiment, a first post 120e and a first cover 110e of a first inner component 100e are made of one piece, and a second post 220e and a second cover 210e of a second inner component 200e are made of one piece.

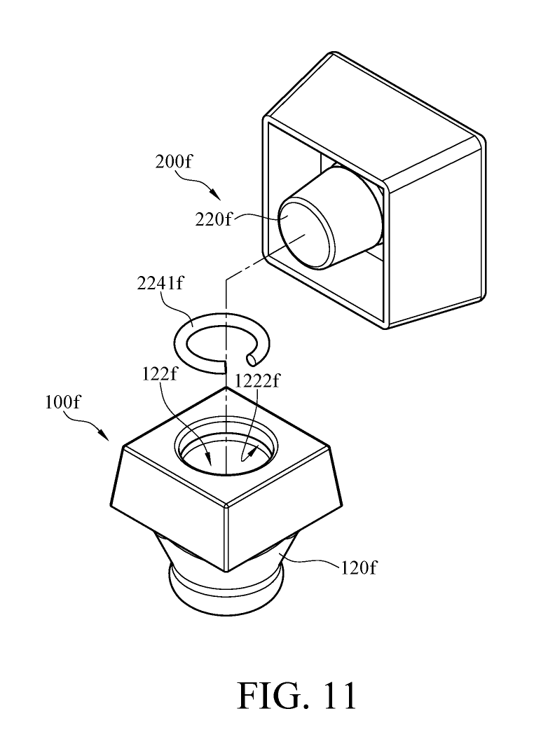

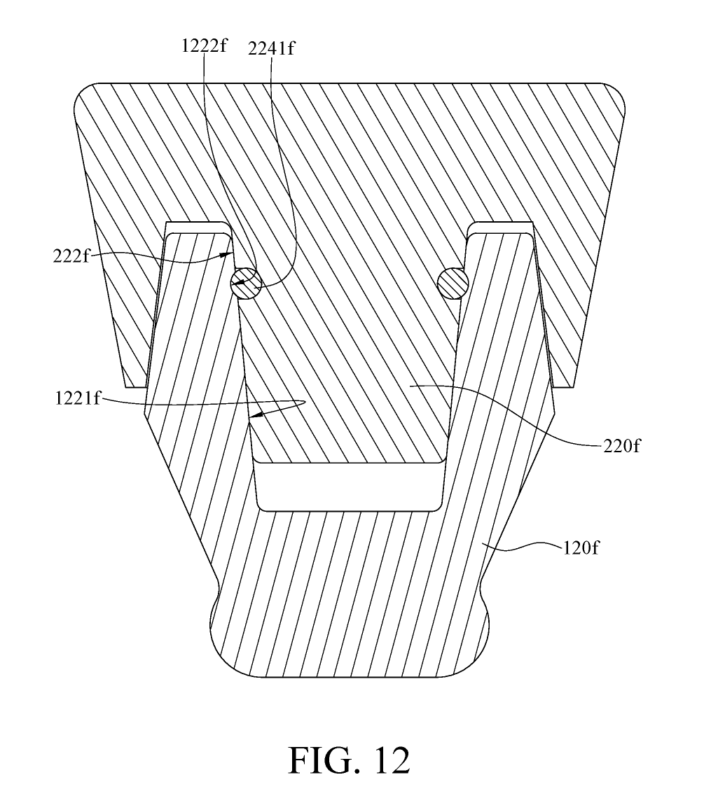

Then, please refer to FIG. 11 and FIG. 12. FIG. 11 is an exploded view of a first inner component and a second component of an artificial denture according to a sixth embodiment of the disclosure. FIG. 12 is a cross-sectional view of the first inner component and the second component in FIG. 11.

In this embodiment, a first post 120f of a first inner component 100f has a hole 122f, an annular inner surface 1221f and a first positioning portion 1222f. The annular inner surface 1221f forms the hole 122f. The first positioning portion 1222f is, for example, an annular groove. The first positioning portion 1222f is located on the annular inner surface 1221f. A second post 220f of a second inner component 200f further has an outer surface 222f and a second positioning portion 2241f. The second positioning portion 2241f is, for example, a ring. The second positioning portion 2241f is detachably sleeved on a groove of second post which is located on the outer surface 222f, but the present disclosure is not limited thereto. In some other embodiments, the second positioning portion may be directly sleeved on the outer surface of the second post and protrude from the second post in a radial direction thereof. Furthermore, in some other embodiments, the second positioning portion and the second post may be made of one piece. In such a case, the second positioning portion is an annular rim protruding from the second post in the radial direction thereof. The first positioning portion 1222f and the second positioning portion 2241f are engaged with other so as to position the second inner component 200f with the first inner component 100f.

As shown in FIG. 11, the first positioning portion 1222f is the ring, and the second positioning portion 2241f is in a ring shape, but the present disclosure is not limited thereto. In some other embodiments, the first positioning portion may not be the ring, and the second positioning portion may not be in a ring shape. For example, one of the first positioning portion and the second positioning portion may be a block, and the other of them may be a slot which has a shape corresponding to the block. In such a case, the quantities of the first positioning portion and the second positioning may be both plural.

According to the artificial denture as discussed above, the artificial denture has the second inner component movably inserted into the first inner component which is embedded into the carrier, therefore the outer force applied on the tooth crown is equivalently applying on the contact point of the first and second inner components which is closer to the alveolar bone than the tooth crown. As such, the torque on the alveolar bone is reduced, thereby decreasing the risk of breaking the alveolar bone.

In addition, when the second positioning portions are located at the first positioning portion, there is still a portion of the first positioning portion not occupied by the second positioning portions and can allow the second inner component to further move toward the first inner component. Therefore, when a force is applied on the tooth crown along an axial direction of the first post, the second inner component still has a small distance to move so as to press against the buffering component with the three buffering parts, such that the buffering component can absorb the force.

During the movement of the buffering parts, the buffering parts are in contact with the annular inner surface so as to force the buffering pars to deform to decrease the buffering holes, which also helps to absorb the force applied on the artificial denture in the radial direction of the first post. As such, the artificial denture can resist the forces in both the axial and radial direction of the first post, thereby further preventing the alveolar bone from being broken by the artificial denture.

It will be apparent to those skilled in the art that various modifications and variations can be made to the present disclosure. It is intended that the specification and examples be considered as exemplary embodiments only, with a scope of the disclosure being indicated by the following claims and their equivalents.

What claimed is:

1. An artificial denture, configured to be fixed to a carrier, comprising:
a first inner component configured to be fixed to the carrier, the first inner component comprising a first cover and a first post connected to each other, wherein the first post has a hole;
a second inner component comprising a second cover and a second post connected to each other, wherein the second cover is detachably sleeved on the first cover, and the second post is inserted in the hole of the first post so as to be fixed to the first inner component; and
a tooth crown covering the second cover of the second inner component.

2. The artificial denture according to claim 1, wherein the first post and the first cover of the first inner component are made of one piece, and the second post and the second cover of the second inner component are made of one piece.

3. The artificial denture according to claim 1, wherein the first post of the first inner component is mounted to the first cover, and the second post of the second inner component is mounted to the second cover.

4. The artificial denture according to claim 3, wherein the first cover comprises a first top plate and a first side wall connected to each other, the first top plate has a first through hole, the first post is mounted on the first top plate, the hole is exposed from the first through hole, the second cover comprises a second top plate and a second side wall connected to each other, the second top plate and the second side wall form an accommodating space therebetween, the second post is mounted on the second top plate, a portion of the second post is located in the accommodating space, the first cover is accommodated in the accommodating space, the second side wall is detachably in contact with the first side wall, and a portion of the second post is inserted in the hole.

5. The artificial denture according to claim 4, wherein the first post has an annular flange, the annular flange protrudes from the first post in a radial direction thereof, the annular flange is located at a side of the first post close to the first cover, and the annular flange is mounted on the first top plate.

6. The artificial denture according to claim 4, wherein the second post has an annular flange, the annular flange protrudes from the second post in a radial direction thereof, the annular flange is located at a side of the second post close to the second cover, and the annular flange is mounted on the second top plate.

7. The artificial denture according to claim 4, wherein the first top plate has a plurality of recess openings connected to the first through hole, the first post has a plurality of protrusions protruding from the first post in a radial direction thereof, the first post is located at the first through hole, the first post is rotatable between a removable state and a engaged state; when the first post is in the removable state, the plurality of the protrusions are respectively aligned with the plurality of recess openings, and the first post is detachable from the first cover; and when the first post is in the engaged state, the plurality of protrusions are respectively misaligned with the plurality of recess openings.

8. The artificial denture according to claim 4, wherein the second top plate has a second through hole and a plurality of recess openings, the second post has a plurality of protrusions, the plurality of protrusions protrude from the second post in a radial direction thereof, the second post is located at the second through hole, the second post is rotatable between a removable state and a engaged state; when the second post is in the removable state, the plurality of protrusions are respectively aligned with the plurality of recess openings, and the second post is detachable from the second cover; and when the second post is in the engaged state, the plurality of the protrusions are respectively misaligned with the plurality of recess openings.

9. The artificial denture according to claim 4, wherein the first top plate has a plurality of protrusions, the plurality of protrusions are located at the first through hole, the first post has a plurality of recess openings and an annular groove, the plurality of recess openings are connected to the annular groove, the plurality of protrusions are located at the annular groove, the first post is rotatable between a removable state and a engaged state; when the first post is in the removable state, the plurality of protrusions are respectively aligned with the plurality of recess openings, and the first post is detachable from the first cover; and when the first post is in the engaged state, the plurality of protrusions are respectively misaligned with the plurality of recess openings.

10. The artificial denture according to claim 4, wherein the second top plate has a plurality of protrusions and a second through hole, the plurality of protrusions are located at the second through hole, the second post has a plurality of recess openings and an annular groove connected to the plurality of recess openings, the plurality of protrusions are located in the annular groove, the second post is rotatable between a removable state and a engaged state; when the second post is in the removable state, the plurality of protrusions are respectively aligned with the plurality of recess openings, and the second post is detachable from the second cover; and when the second post is in the engaged state, the plurality of protrusions are respectively misaligned with the plurality of recess openings.

11. The artificial denture according to claim 1, wherein the second post has an outer surface and a plurality of buffering holes formed on the outer surface, the plurality of buffering holes divide the second post into a plurality of buffering parts.

12. The artificial denture according to claim 1, further comprising a buffering component located in the hole, wherein the second post is in contact with the buffering component.

13. The artificial denture according to claim 1, wherein the first post has an annular inner surface and at least one first positioning portion, the annular inner surface forms the hole, the at least one first positioning portion is located on the annular inner surface, the second post of the second inner component has an outer surface and at least one second positioning portion located on the outer surface, the first positioning portion and the second positioning portion are engaged with other so as to position the second inner component with the first inner component.

14. The artificial denture according to claim 13, wherein the second positioning portion is an annular rim protruding from the second post in a radial direction thereof, and the first positioning portion is an annular groove located on the annular inner surface.

15. The artificial denture according to claim 13, wherein the second positioning portion is a ring detachably sleeved on the second post and protruding from the second post, and the first positioning portion is an annular groove located on the annular inner surface.
